(19) United States
(12) Patent Application Publication
(10) Pub. No.: US 2004/0048041 A1
(43) Pub. Date: Mar. 11, 2004

(54) Sheeting material

(76) Inventor: Richard Keith Arend Menage, York (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/235,275

(22) Filed: Sep. 5, 2002

(51) Int. Cl. B32B 3/10

(52) U.S. Cl. 428/138; 156/289; 156/91

(57) ABSTRACT

Sheeting is disclosed for securing to a structure to provide a barrier isolating one side of the sheeting from the other, which sheeting comprises an impervious base sheet and a strip of material joined to the base sheet, which strip includes a series of openings so arranged that a tie can engage one or more openings and in the strip to hold the sheeting on a structure, wherein the part of the strip in the region of the openings is not joined to the base.

### TECHNICAL FIELD

The present invention relates to sheeting used for containing material within an area, generally to prevent the material escaping to open atmosphere, causing pollution or health damage or to prevent the open atmosphere affecting the area, e.g. rain, snow wind and atmospheric pollution.

### PRIOR ART

Containment sheeting is well known and is often supplied in rolls. Lengths of the sheeting are cut from the roll and secured to a structure, for example scaffolding or tenting frames to hold the sheeting in place and form a barrier. The sheeting is secured to the structure by ties. Ties can take the simple form of cable ties, which pass through holes in the sheeting and around looped around a part of the structure, for example a scaffolding pole and secured.

Am alternative arrangement is described in GB-A-2254879, in which the tie can be a length of elasticated rope, at one end of which is formed a transverse “T” bar and the other end of which includes a hook. The rope passes through an opening in the sheeting; the T-piece is too large to fit transversely through the opening and so is held on one side of the sheet while the hook end of the rope, which is located on the other side of the sheet, is passed around a scaffolding pole and secured in a closed loop by engaging the hook onto the elasticated rope.

In its simplest form, the tie can simply be a piece of rope.

All the above methods require the tie to pass through an opening in the sheeting, which allows water and other materials to pass through the sheeting. Thus, containment or isolation is not complete.

GB-2273519 describes a containment sheet in which a reinforcing strap is secured in a hem or within a strip of material secured to the sheet. This allows ties to pass through the strap to secure the sheet to a scaffolding pole without penetrating through the sheet of material. Unfortunately, the securing of the strap to the sheet material is expensive.

It is also known to secure a tab having an eyelet to sheeting. Ties can be passed through eyelet to secure the sheet to the scaffold structure. Unfortunately, such an arrangement is expensive to manufacture and also involves making a hole in the sheeting to fix the tab so that, if the tab ever works loose, an opening is provided for water and other materials.

The present invention provides a system for securing sheeting to scaffolding and other structures to provide a barrier isolating one side of the sheeting from the other that minimises the chance of water and other materials passing through the barrier.

### DISCLOSURE OF THE INVENTION

According to the present invention, there is provided sheeting for securing to a structure to provide a barrier isolating one side of the sheeting from the other, which sheeting comprises an impervious base sheet and a strip of material joined to the base sheet, said strip including a series of openings so arranged that a tie can engage one or more openings in the strip to hold the sheeting on a structure, wherein at least a part of the strip around each of the openings is not joined to the base sheet. Such an arrangement does not include a strap or other reinforcing element within the strip around which a tie can be secured, as is required by GB-2273519.

The openings may be arranged in pairs with the part of the strip between the openings not being joined to the base sheet so that a tie can pass in through one of the openings and out of the other and then around the structure to hold the sheet onto the structure. In such an arrangement, the separation between the openings of each pair of openings is preferably less than about 15 cm, more preferably less than about 10 cm and more preferably less than 5 cm, e.g. about 2 cm.

As used herein the term “opening” is not restricted as to shape and includes, for example round and oval holes and slots.

Because the tie does not penetrate through the impervious base layer but rather through one of the pairs of adjacent openings, no water or other material can pass through the sheeting.

Alternatively, a tie of the above-mentioned type can be used having a length of elasticated rope with a “T” bar at one a hook at the other. The sheet can be secured by passing the “T” bar axially through one of the openings in the strip and then arranging the bar transversely within the strip to that it cannot be pulled transversely out through the opening. In this case, the hooked end of the rope can be hooked around the supporting structure to form a closed loop, thereby holding the sheet onto the structure and form the barrier. The openings must have a diameter smaller that the transverse length of the “T” bar, e.g. less than 6 mm and preferably in the range of 2 to 5 cm.

The sheeting is relatively inexpensive to produce since the strip can be welded to the base sheet during the manufacturing process and therefore is only marginally more expensive to produce than existing sheeting. It is much cheaper to produce than the sheeting described in GB-2273519 because no strap or other reinforcing element is provided within the strip.

The strip preferably extends longitudinally along the length of the base sheeting since that provides the simplest method of incorporating the strip during the manufacturing process.

The strip can be secured to the base sheeting by welding or by any other method, e.g. stitching and gluing, but welding is greatly preferred since it allows rapid incorporation of the strip during the process of manufacturing the sheeting.

Preferably, the edge regions only of the strip are welded or otherwise joined to the base sheet, leaving the central part of the strip between the edges unjoined to the base sheet. The openings are then provided in the central area. The avoidance of welding in the central area can be achieved by incorporating a length of stop off material between the strip and the base sheet that prevents welding in the central area. Alternatively nip rollers can be provided that engage only the edge regions and therefore limit the welding to the edge regions. However, it can be difficult to prevent welding in the central region in a manufacturing process and the use of stop off materials is preferred. Naturally, if the joining of the strip to the base sheet is provided by stitching or gluing, this is not a problem.

In order to provide a good bond between the base sheet and the strip, the strip is preferably made of the same material as the base sheet. However, this is not necessary if the materials from which the base sheet and the strip are made are compatible and can be welded together.

When provided in pairs, the openings of each pair of adjacent openings can be spaced either longitudinally (with respect to the length of the base sheet) or transversely. Indeed, in order to simplify the attachment of the sheeting to either vertical or horizontal parts of the structure, the openings may be grouped in groups of three or four so that the tie can be passed either transversely with respect to the length of the sheeting or longitudinally.

In order to provide a substantial barrier, it is often necessary to join sheets together. The edges of the sheeting can be sealed to prevent water and other material from passing between the sheets. Such sealing can be achieved, for example, by adhesive tape, mastic or other joining means. However, it is often problematic to seal the edges well if there is a tie in the vicinity of the edge. On the other hand, if there is no tie in the vicinity of the edge, the edges can flap in the wind, which can break the seal. The sheeting of the present invention is beneficial in this regard; because the tie does not penetrate through the sheet, sealing is made easier, as will be apparent from the description below.

Preferably more than one strip is provided in the sheeting and more preferably the sheeting includes a strip along each of its longitudinal edges and preferably also at least one longitudinal strip located between the edge strips.

The sheeting can be used in any circumstances in which it is desired to isolate an environment, for example to prevent a building from being open to the weather during reconstruction or refurbishment, to isolate a building (or anything else) while being painted, to prevent material escaping into the environment, for example when a building is being demolished, to provide protection from the weather, for example by securing the sheeting to a suitable frame to provide tenting or merely for the erection of a barrier to prevent people seeing into a restricted area.

According to a second aspect of the present invention, there is provided a method of manufacturing sheeting as described above, which method comprises applying a strip of material containing the said openings to the base sheet at a temperature that welds the strip to a base sheet and preventing the welding of the strip to the base sheet in the region of the said openings by providing a length of stop off material between the base sheet and the said strip.

### BRIEF DESCRIPTION OF DRAWINGS

The present invention will now be exemplified in further detail by reference to the accompanying drawings in which:

FIGS. 1a and 1b show a prior art arrangement for securing sheeting to a scaffolding pole;

FIGS. 2a and 2b show an alternative prior art method for securing sheeting to a scaffolding pole;

FIG. 3 is a view of sheeting in accordance with the present invention;

FIG. 4 is a sectional view through the sheeting of the present invention and through an adjacent scaffold tube illustrating the securing of the sheeting to the tube;

FIG. 5 is a sectional view through two edge regions of sheeting according to the present invention and a scaffolding pole showing the manner in which adjacent lengths of sheeting of the present invention can be joined together to provide an impervious barrier;

FIG. 6 is the same as FIG. 5 but illustrates the joining of the two lengths of sheeting;

FIG. 7 is a sectional view showing the manner in which adjacent lengths of sheeting can be joined together to form an impervious barrier; and

FIG. 8 is a schematic view showing the manufacture of sheeting in accordance with the present invention.

### BEST MODE OF PUTTING THE INVENTION INTO OPERATION

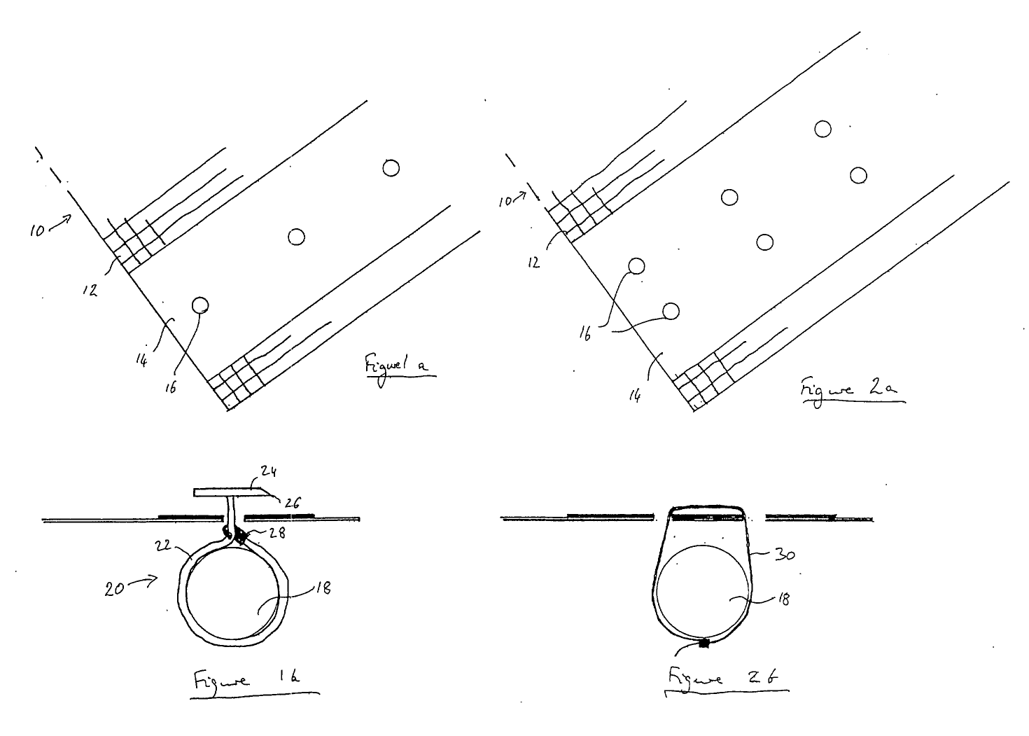

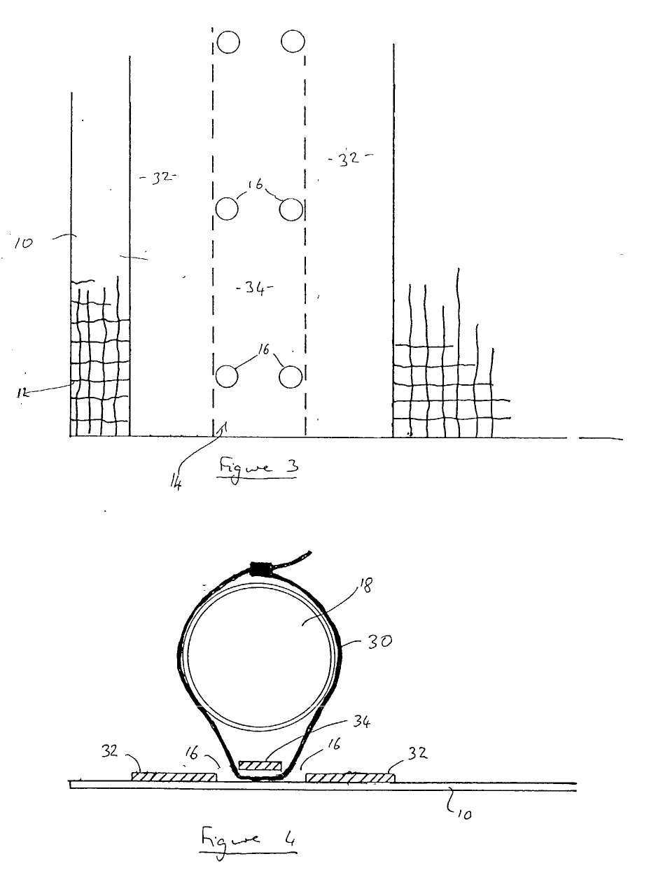

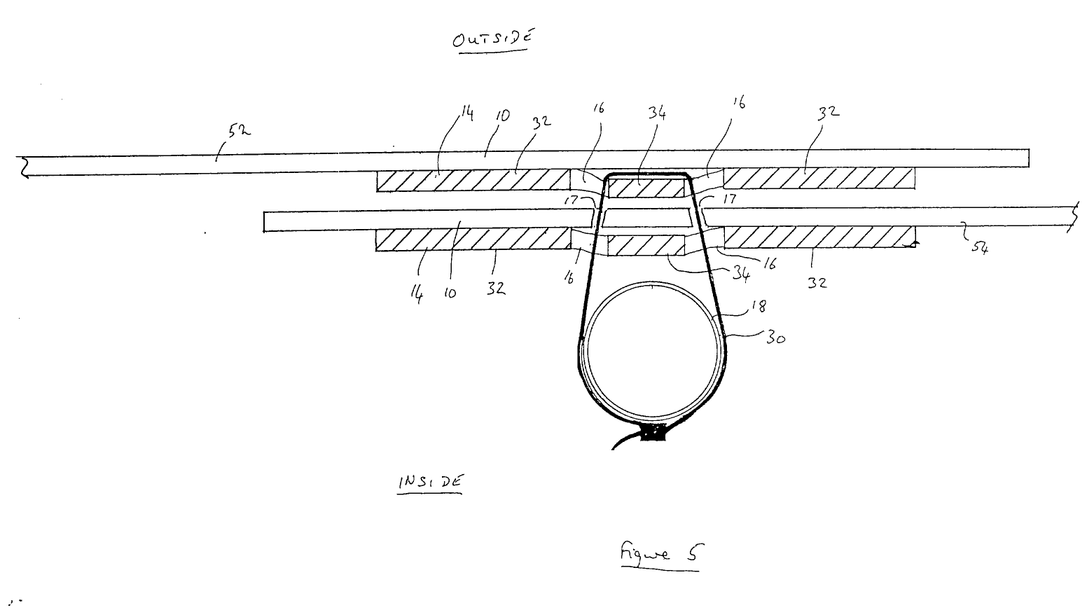

Referring initially to FIGS. 1 and 2, these drawings illustrate prior art methods of joining sheeting to scaffolding poles. The sheeting comprises a base sheet 10 made by sandwiching a net 12, known as “scrim”, of polypropylene fibres between two low density polyethylene sheets.

A strip of reinforcing material 14 is welded to the base sheet 10 across its whole length and width and includes openings 16. The reinforcing strip is made from closely woven fibre, e.g. high density polyethylene (to provide strength) and is coated with a layer of low density polyethylene to provide good welding characteristics between the reinforcing strip 14 and the base sheet 10. This welding is achieved during manufacture by applying the strip 14 to the base sheet 10 while the base sheet 10 is still hot and pressing the strip 14 against the base sheet 10, for example with a nip roller, as will be described later.

The sheeting illustrated in FIG. 1a is joined to a scaffolding pole 18 by a tie 20 that consists of a length of elasticated rope 22 having, at one end, a T bar 24 and, at the other end, a hook 28. The T bar 24 has a point 26 at one of its ends that can be inserted through the opening 16 in the reinforcing strip 14 to penetrate the sheeting and thereby form a hole through the sheeting. The elasticated rope 22 is then passed around the scaffolding pole 18 and secured in a closed loop by clipping the hook 28 onto the rope 22.

FIG. 2 shows a similar arrangement to FIG. 1 except that pairs of openings 16 are provided in the reinforcing strip 14. A cable tie 30 passes through the two openings 16 and around the scaffolding pole 18 before being secured in a closed loop to hold the sheeting 10 to the scaffolding pole 18.

As can be seen from FIGS. 1 and 2, the prior art method provides holes through the sheeting where it is secured to the scaffolding pole 18 that can allow water or other material to pass through the sheeting.

Referring now to FIG. 3, which discloses an arrangement of the present invention, there is provided a base sheet 10 in the same form as described above and a reinforcing strip 14 made of the same material as described above. Pairs of adjacent openings 16 are also provided; these openings are separated by a distance of approximately 2 cm. The reinforcing strip 14 is welded, as described above, to the base sheet 10 in the edge regions 32. The central region 34 remains unwelded; the openings are provided in the central region 34 of the strip 14.

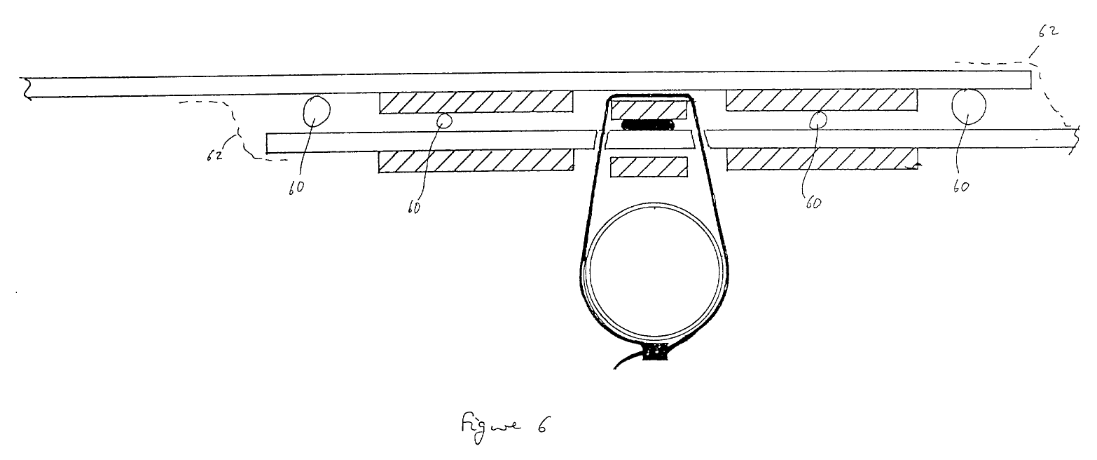

Referring now to FIG. 4, the method of securing the sheeting 10 of FIG. 3 to a scaffolding tube 18 is shown. A cable tie 30 is passed around the scaffold tube 18 and is passed through the openings 16 of an adjacent pair of openings. The cable tie is then formed into a closed loop and secured, thereby holding the sheeting 10 in relation to the scaffold tube 18. It is possible to tighten the cable tie 30 further than that shown.

As can be seen from FIG. 4, the arrangement of the present invention does not puncture the base sheet 10 and it therefore retains its integrity as a barrier.

The sheeting shown in FIG. 3 can also be secured using a tie with a “T” bar 24 shown in FIG. 1b. In this case, the “T” bar is pushed axially though one of the openings 16 so that it is located wholly within the central region 34 between the strip 14 and the base sheet 10. It can then be secured to a scaffolding pole in the manner describes in connection with FIG. 1b.

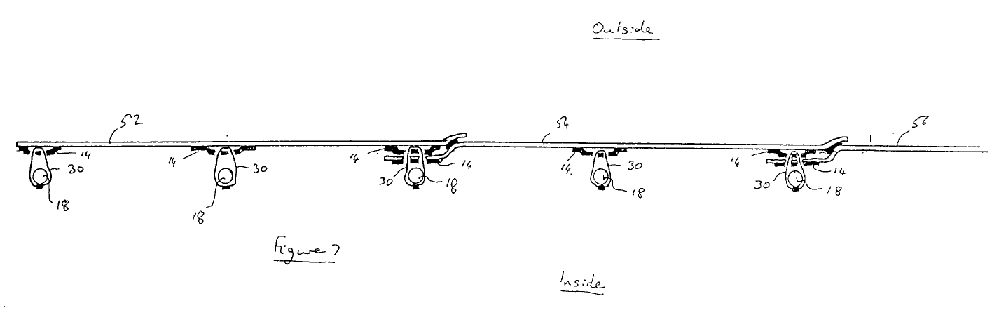

It is usually necessary to join sheets together in order to provide a continuous barrier over a wide area. The present invention can achieve this in a manner illustrated in connection with FIG. 5. Two sheets, an outer sheet 52 and inner sheet 54 are to be joined together. Each is provided in its edge region with a reinforcing strip 14, each of which is welded in its edge regions 32 to base sheet 10 of sheets 52 and 54. However, the central regions 34 of each of the reinforcing strips 14 are not welded to the base sheet 10, as described above in connection with FIG. 4.

A cable tie 30 is passed through the openings 16 of the inner sheet 54. Additional openings 17 are also made in the base sheet 10 of inner sheet 54 and the tie 30 is passed through the openings 16 and holes 17 in inner sheet 54 and through the openings 16 in the outer sheet 52 and looped around a scaffold tube 18 and formed into a closed loop as shown to secure the inner and outer sheet 52, 54 to the scaffold tube 18. Even though the base sheet 10 of inner sheet 54 is penetrated by holes 17, these holes are covered by outer sheet 52 and accordingly the integrity of the barrier is maintained since the base sheet 10 of the outer sheet 52 is unpunctured.

The integrity of the join between the sheets can be supplemented by adhesive, which may be glue, mastic, tape or spray at any one or more of locations 60 shown in FIG. 6. Alternatively, or in addition, the edges of the inner and outer sheets 52, 54 may be joined to the other by adhesive tape, shown schematically at 62. The glue and mastic may be provided in any known means, for example using an extrusion of mastic or a spray of adhesive glue. Alternatively, the edges may be welded together at any of positions 60 by heat, e.g. with a hot-air hand welder, or using a solvent.

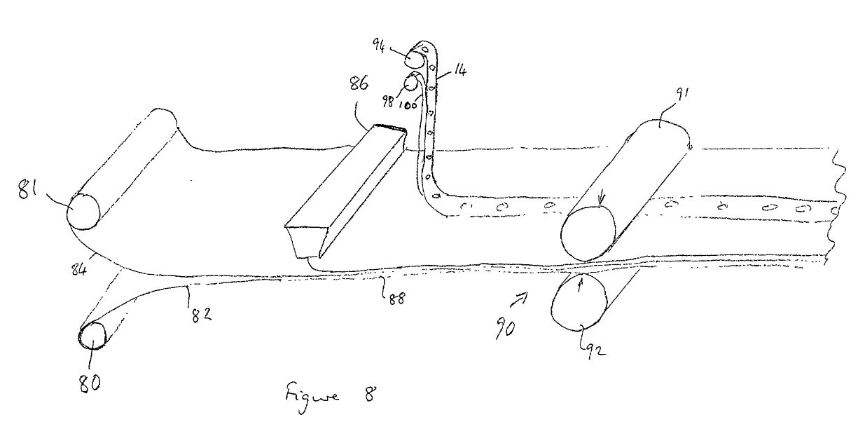

FIG. 7 shows an arrangement of several sheets, 52, 54 and 56 each secured to scaffold tubes 18 by cable ties 30 passing around the scaffold tube and through the openings in the reinforcing strips 14, in a manner described above. In this way, a barrier of almost any length and any height can be provided. Such a barrier isolates one side (“outside”) from the other side (“inside”) and so protects the inside from rain and wind on the inside. Likewise, dust and debris inside the barrier does not pass to the outside and so is contained.

The invention described in connection with FIGS. 5-7 has shown the joining of lengths of sheeting along their longitudinal edge, it is possible also, in the manner described, to join lengths of sheeting along their transverse edges in the same manner. If, at any one place, more than two edges are to be joined, the base sheet 10 of the outermost sheet remains unpunctured although the inner sheets may be punctured to join the sheets together in the manner described in connection with FIG. 6.

Although FIGS. 3-7 have described the use of cable ties 30 to join the sheet to scaffold tubes 18, other ties may be used, for example rope or elastic ties.

A method of manufacturing the scaffold sheeting according to the present invention is shown schematically in connection with FIG. 8. A reel 80 of low density polyethylene film and a reel 81 of polypropylene scrim are provided. The polyethylene film 82 and the scrim 84 are pulled off their respective reels 80, 81 so that the scrim 84 lies immediately above the polyethylene film 82. An extruder 86 deposits a layer of polyethylene on the film and scrim 82, 84. In this way, a sandwich 88 is formed by the molten polyethylene, the scrim 84 and the film 82, which is passed between a pair of rollers 90, the top roller being a nip roller 91 that applies pressure to the sandwich to bond them all together. The lower roller 92 is a cooling roller. The sheeting then passes to a cutting and packing section (not shown). Thus far, the process is known. However, immediately after the extruder 86, a reel 94 of reinforcing strip 14 is provided. A further reel 98 of stopping off material 100 is also provided; the width of the stopping off material is less than the width of the strip 14 and so the central parts of the strip overlap the stopping off material 100 but the outer edge areas of the strip extend beyond the stopping off material 100. The strip 14 and the stopping off material 100 are applied to the layer 88 and the strip 14 is heat welded to the layer 88 in those edge areas of the strip that extend beyond the stopping off material 100; welding is achieved without additional heating by virtue of the high temperature of layer 88 following extrusion. The pressure applied by the nip roller 91 bonds/welds the strip 14 to the extruded layer 88 except in the areas in which stopping off strip 100 is present. Because the strip of stop off material 100 is sandwiched between the reinforcing strip 14 and the polyethylene layer 88 it prevents the heat welding in the central region 34 of the strip.

What I claim is

1 Sheeting for securing to a structure to provide a barrier isolating one side of the sheeting from the other, which sheeting comprises an impervious base sheet and a strip of material joined to the base sheet, said strip including a series of openings so arranged that a tie can engage one or more openings in the strip to hold the sheeting on a structure, wherein at least a part of the strip around each of the openings is not joined to the base sheet and wherein the sheeting does not include a strap or other reinforcing element extending longitudinally between the strip and the base sheet.

2 Sheeting as claimed in claim 1, wherein the openings are arranged in pairs and wherein the part of the strip between the openings is not joined to the base sheet so that a tie can pass through the openings and then around a structure to hold the sheet onto the structure.

3 Sheeting as claimed in claim 2, wherein the separation between the openings of each pair of adjacent openings is less than about 15 cm,

4 Sheeting as claimed in claim 3, wherein the separation between the pairs of adjacent openings is 2 to 10 cm.

5 Sheeting as claimed in claim 1, wherein openings have a diameter of in the range of 1 to 6 cm.

6 Sheeting as claimed in claim 1, wherein the strip extends longitudinally along the length of the base sheeting.

7 Sheeting as claimed in claim 1, wherein the strip is secured to the base sheeting by welding.

8 Sheeting as claimed in claim 1, wherein the strip has edge regions and a central region located between said edge regions and wherein the edge regions only of the strip are joined to the base sheet, leaving the central region of the strip unjoined to the base sheet.

9 Sheeting as claimed in claim 1, wherein at least two strips are provided in the sheeting.

10 Sheeting as claimed in claim 9, wherein the base sheet has two opposed longitudinal edges and the sheeting includes a strip along each of the said longitudinal edges.

11 Sheeting as claimed in claim 10, which also includes at least one further longitudinal strip located between the said edges.

12 A method for securing sheeting to a structure to provide a barrier isolating one side of the sheeting from the other, which sheeting comprises an impervious base sheet and a strip of material joined to the base sheet, which strip includes a series of openings and wherein a part of the strip in the region of the openings is not joined to the base sheet, the method comprising engaging a tie in one or more openings and to a supporting structure to hold the sheeting on the structure to form the said barrier.

13 A method as claimed in claim 12, wherein the tie is a loop that extends between adjacent openings in the strip and around at least part of the said structure.

14 A method as claimed in claim 13, wherein the tie includes an element located between the base sheet and the strip, wherein the tie extends out through one of said openings and is engaged to at least part of the said structure.

15 A method of manufacturing sheeting as claimed in claim 1, which method comprises applying a strip of material containing a series of openings to the base sheet at a temperature that welds the strip to a base sheet and wherein the method further comprises preventing the welding of the strip to the base sheet in the region of the said openings by providing stop off material between the base sheet and the said strip.
